(19) United States
(12) Patent Application Publication
(10) Pub. No.: US 2007/0272714 A1
(43) Pub. Date: Nov. 29, 2007

(54) Funnel Bucket Device

(76) Inventor: Richard J. Harpenau, Jupiter, FL (US)

Correspondence Address: AKERMAN SENTERFITT, P.O. BOX 3188, WEST PALM BEACH, FL, 33402-3188, US

(21) Appl. No.: 11/420,333

(22) Filed: May 25, 2006

(51) Int. Cl. B67D 3/00

(52) U.S. Cl. 222/530

(57) ABSTRACT

A funnel bucket device for storing, transporting and dispensing liquids, comprised of a housing for holding a liquid, having an opening at an upper surface, a generally concave inclined bottom surface, and having a support system to support the housing when placed on a substantially level surface. The device further comprises an outlet at a low point of the bottom surface, to which a hose is connectable, and a hose storage system operating by wrapping the hose around the housing and securing the hose in place in at least one groove and at least one hose notch, whereby the hose is not caused to be disengaged from the dispensing device or kinked by the action of wrapping the hose around the housing.

### FIELD OF THE INVENTION

The present invention relates to a funnel bucket device for transporting, storing and dispensing liquids. More specifically, the funnel bucket device provides a means for easily dispensing large amounts of liquids into a container or tank to be filled with the liquid product. The funnel bucket device can be used with any liquids, including water, fuel, oil, and food products.

### BACKGROUND OF THE INVENTION

Often it can be difficult to transport liquids from a source container to a destination container. In some cases, it is possible to bring the destination container to the source container and use some type of device to transfer the liquid. In other cases, a transfer container may be filled at the source of the liquid, transported to the location of second container, and the contents of the transfer container are transferred to the destination container. At any point in the transfer of the liquid, devices such as pumps, funnels, hoses, or valves, may be used to facilitate the transfer. However, in certain cases, even with such devices it can be difficult to achieve an efficient transfer of liquids.

For example, refueling watercraft is often problematic for the user. Users of watercraft, especially smaller personal watercraft, do not typically maintain large reserves of fuel or any type of fuel dispensing system on hand to refuel the watercraft. Furthermore, small personal watercraft are typically not stored at a marina or close to marine fuel pumps. Rather, in order to refuel the watercraft, the typical user employs one of two options, each of which can be problematic and inconvenient for the user.

The first option is to transport the watercraft to a refueling point. Unfortunately, the number and location of refueling points for watercraft in the water is often limited. This option may require that the watercraft have enough fuel to reach a refueling point, such as a marina, and refueling can be often time consuming. Furthermore, fuel is further expended in reaching the location where the watercraft is to be used, reducing the amount of available fuel for the planned watercraft activity. Such problems are typically overcome by towing the watercraft, on a trailer attached to an automobile, to an automobile refueling station and refueling the watercraft there. Unfortunately this solution requires a user to mount the watercraft on a trailer, hitch the trailer to a suitable automobile, and then drive the automobile, the trailer, and the watercraft to the refueling station. After refueling, the watercraft and trailer must then be transported back to the point where the watercraft is to be used. Again, fuel and time is wasted during the transport and refueling of the watercraft. Furthermore, regardless of the way the watercraft reaches the refueling point, the fuel and time costs increase as the size of watercraft increases.

The second option is to bring the fuel to the watercraft. Unfortunately, such an option can be difficult, wasteful, and dangerous. Since several gallons of fuel are always required in order to refuel a watercraft, a watercraft user will typically require the use of at least a five gallon container of fuel, if not several. While the transport of such containers in an automobile or other vehicle is not typically problematic, the handling of such containers by a user during the refueling process may be so. Such containers typically dispense fuel by requiring the user to lift the container and then tilt the container to allow fuel to exit through a spout or other outlet, located on the top of the container. However, a filled five-gallon container of fuel typically weighs between thirty and thirty-five pounds, depending on the container and the type of fuel contained within. As a result, for some individuals, it can be difficult to lift the container, tilt the container, and to maintain the container in such a position as the contents of the container are emptied. Smaller containers could be used, but it would be inefficient to transport, fill, and dispense a large number of smaller containers. It also may be possible to place the container on some support system, during the refueling process, but the design and the fuel inlet of the watercraft may limit this option. A funnel may also be used to facilitate the transfer of the fuel, but its use does completely eliminate the problems of spillage associated with the handling of the fuel container. Pumps also could be used to facilitate the transfer, but the causal user does often not possess a pump. Therefore the result of using such heavy refueling containers is that fuel is commonly spilled, resulting in exposure to dangerous and flammable materials, the loss of fuel and money, and possible harm to the environment or the user.

The refueling problems encountered above are not unique to the watercraft example above. Farmers, woodsman, and other fuel users face similar issues, whenever the distance between the fuel and the device requiring the fuel requires the transport of either the fuel or the device over an extended distance or is otherwise inconvenient. Furthermore, the problems associated with the transport and dispensing of large amounts of fuel are also seen whenever large amounts of liquids, such as liquid food products, water, oil, or other chemicals, need to be transported and dispensed.

Therefore, there is a need for a simple device that allows a user to safely and efficiently transport, store, and transfer liquids between a desired source container and a destination container. Such a device should have the ability to guide liquids, just like a funnel does, but at the same time be able to accept and store large volumes of liquid, just as a bucket or other liquid container does. Furthermore, there is a need that such a device be easy to transport, store, and operate. In all these regards, the present invention, a funnel bucket device, in its various arrangements substantially fulfills these needs.

### SUMMARY OF THE INVENTION

Each arrangement of a funnel bucket device in accordance with the present invention overcomes the problems existing in transporting and dispensing liquids. A funnel bucket device in accordance with an arrangement of the invention comprises a housing or other container to hold the liquid, with an opening on an upper surface, a generally concave bottom surface, and a support system designed to vertically support to the housing on a substantially level surface. The funnel bucket device is further comprised of a liquid dispensing outlet on the housing, where a hose with a first end is connectable to the dispensing outlet, and a storage system enabling a user to wrap a hose around the housing to allow for compact and easy storage and transport of the funnel bucket device. In some arrangements of the invention, the funnel bucket device operates to fill a destination container as follows: first, a hose is first connected to the liquid dispensing outlet on the housing. Second, liquid is added through a top opening in the housing, wide enough to accept liquids from a plurality of sources. Third, the liquid can then flow out the dispensing outlet and into the first end of the hose and out through a second end of the hose, which a user would place in the inlet of a destination container. The housing's concave bottom can be designed so that any liquid in the container would preferentially flow out the dispensing outlet. Fourth, once the user is done dispensing the liquid, the hose can be detached from the dispensing outlet or wrapped around the housing and secured by the storage system. In the various arrangements, the storage system consists of a series of notches and grooves on the housing designed to hold the hose in place.

In other arrangements, the funnel bucket device may be modified by various means. First, the dispensing outlet can be adapted to pivot on the housing, for example by 90 degrees, preventing an attached hose from developing a kink as the hose is stretched out to the destination container. Second, one or more of the sides of the housing may be adapted to allow the housing to be mounted on a wall or posts of various sizes by the use of screws, hooks or other attachment devices. In other arrangements, one or more means of transporting the funnel bucket device may be incorporated into the housing design itself, such as built handles or fingerholes. In other arrangements, a lid may be provided to close off the upper opening during transport, storage, and dispensing of the liquid in the housing, in order to prevent contamination of the interior of the housing or the contents therein. In yet other arrangements, the dispensing outlet may be configured with a valve or other device to regulate the flow of liquid being dispensed.

### BRIEF DESCRIPTION OF THE DRAWINGS

The invention will be better understood and objects other than those set forth above will become apparent when consideration is given to the following description thereof. Such a description makes reference to the following drawings:

FIG. 1 shows a top off-axis front view of an arrangement of the invention with a lid, showing the lid open and with a hose attached.

FIG. 2 shows a side view of an arrangement of the invention with a lid, showing the lid closed and the configuration of the bottom of the housing.

FIG. 3 shows a bottom off-axis front view of an arrangement of the invention with a lid, showing the lid open.

FIG. 4 shows a top off-axis rear view of an arrangement of the invention with a lid, showing the lid open.

FIG. 5 shows a top off-axis front view of an arrangement of the invention with a lid, showing the lid closed and with a hose attached and wrapped around the housing.

### DETAILED DESCRIPTION OF THE INVENTION

With reference now to the drawings, a new funnel bucket device for transporting, dispensing, and storage of liquids, which embodies the principles and concepts of the present invention, will be mainly described in terms of the housing of an arrangement of the invention shown in the accompanying drawings. However, it is to be understood that the invention is not limited in its application to the details of construction and the arrangement of components set forth in the following description or illustrated in the drawings. The invention is capable of other arrangements and of being practiced and carried out in various ways. Also, it is to be understood that the phraseology and terminology employed herein are for the purpose of description and should not be regarded as limiting.

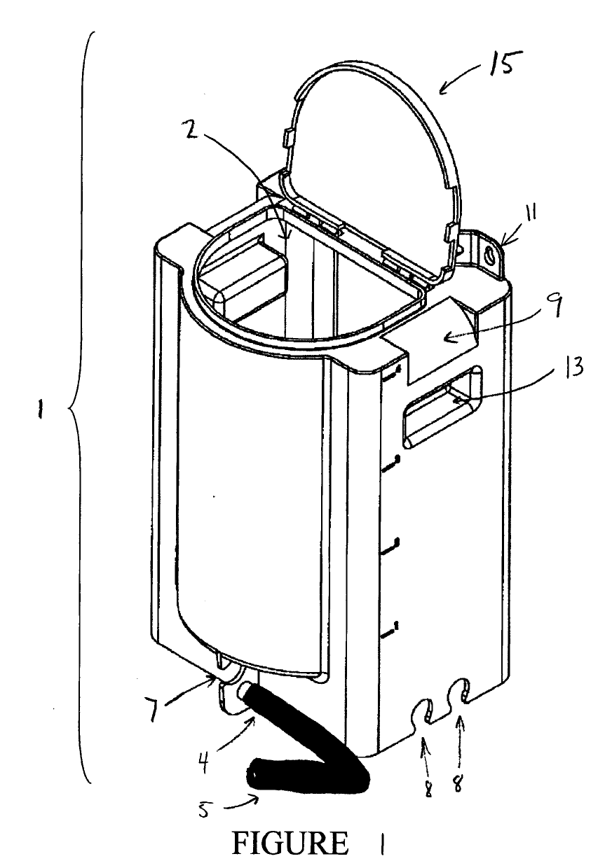

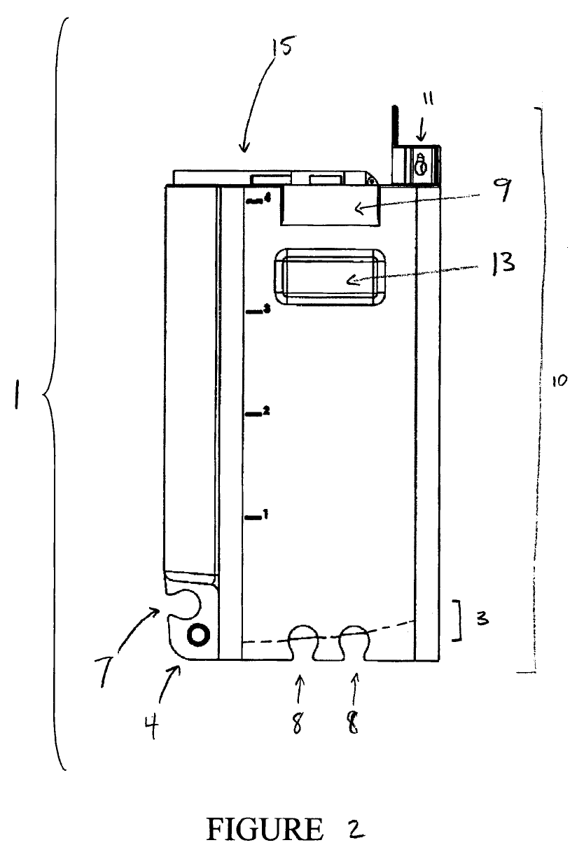

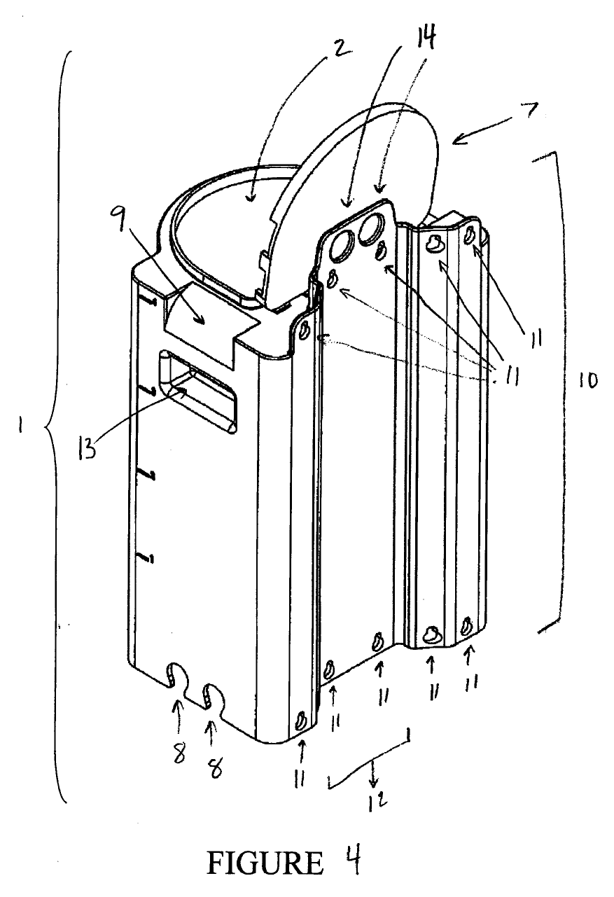

The housing of a funnel bucket device in accordance with an arrangement of the present invention is shown in FIGS. 1-5. In this arrangement, the housing 1 is comprised of an opening 2 in the upper portion or top of the housing. The opening 2 can be made wide enough such that it can accept liquids into the housing from any number of sources. In addition, a wide opening is more advantageous as it allows the liquid to be poured in or to be pumped in without a user having to be very careful not to spill the liquids, the only limitation being the size of the liquid flow or the size of the opening 2. The housing is also further comprised of a concave bottom 3, as shown by the dashed line in FIG. 2, which enables the liquid in the housing to preferentially flow out of the housing 1 through the dispensing outlet 4 and through a hose 5 connected to the dispensing outlet 4. In these and other arrangements, the housing can consist of a material suitable for the liquid to be transported, stored, or dispense. For example, plastics are well-known materials for the use in applications involving gasoline and motor oils. Other materials may be suitable, depending on the liquid. Likewise, other components of the funnel bucket device may be produced with materials according to the intended liquid.

In the arrangement shown in FIGS. 1-5, the dispensing outlet is attached to the lowest side of the concave bottom 3. However, in other arrangements, the lowest portion of the concave bottom 3 may be at the center, rather than the edge of the concave bottom 3 and the dispensing outlet 4 can then be attached at this point, in order to ensure that all the liquid stored in the housing 1 is dispensed. In some arrangements, the dispensing outlet 4 can be configured so that the end of the dispensing outlet 4 is oriented parallel to the side of the housing 1 in order to reduce the overall footprint of the housing 1. Furthermore, in some arrangements, the dispensing outlet 4 may be attached pivotably to the housing 1. This allows the dispensing outlet 4 to pivot or turn as the hose 5 is connected or stretched, in order to prevent kinks of an attached hose at the dispensing outlet 4. In these arrangements, the dispensing outlet 4 can be configured to rotate at the point of attachment of the dispensing outlet 4 and the housing 1. In some arrangements, the dispensing outlet 4 can be configured to pivot by at least 90 degrees. In arrangements where the funnel bucket device is used to store a liquid, the dispensing outlet 4 may be configured to act as a valve or flow regulating device. In such arrangements, a valve control may be attached to the dispensing outlet 4 or the valve control may be actuated by the pivoting action of the dispensing outlet 4. In other arrangements, a separate valve may be attached to the dispensing outlet 4.

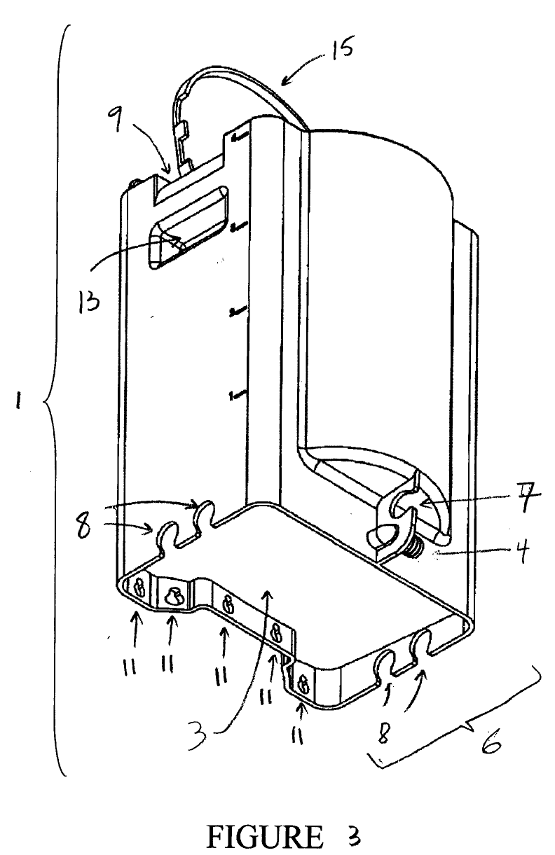

The housing 1 is also further comprised of a support system 6, designed to support the housing 1 vertically when it is placed on a substantially level surface. In the arrangement shown in FIGS. 1-5, the support system 6 is comprised of a substantially continuous edge, perpendicular to the vertical axis of the housing, as shown in FIG. 3. However, in other arrangements, non-continuous edges, legs, stubs, or other types of support devices could be use to comprise the support system 6.

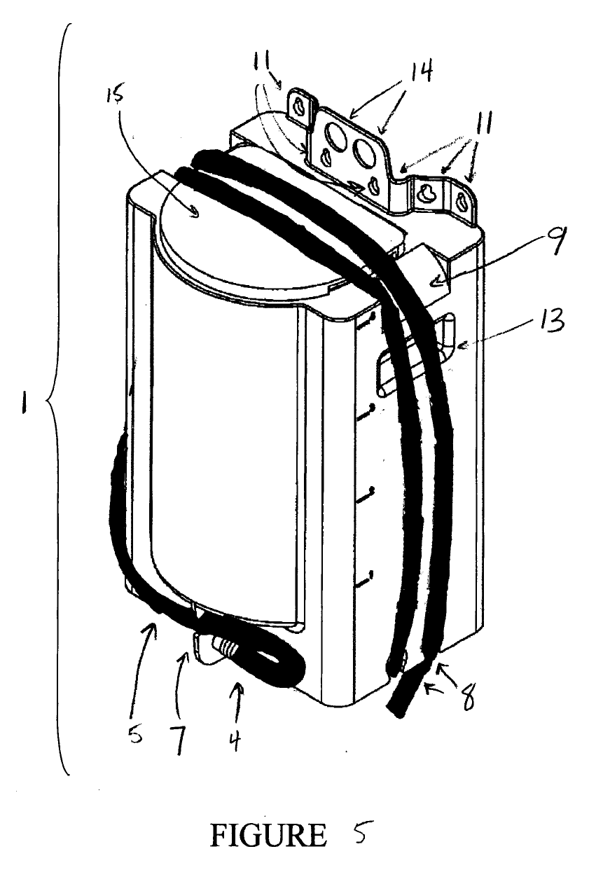

The housing 1 is also further comprised of hose storage system comprising a dispensing outlet notch 7, hose storage notches 8, and grooves 9 to allow for storage of a hose 5 of the funnel bucket device. The dispensing outlet notch 7 may be located adjacent the dispensing outlet. The storage notches 8 and grooves 9, may be located on the lower and upper portions of the housing, respectively, opposite to each other. Although a hose 5 attached to the dispensing outlet 4 may be detached to store the funnel bucket device, in the arrangement shown in FIGS. 1-5, the hose 5 need not be detached from the dispensing outlet 3 to store the funnel bucket device. Instead, as shown in FIG. 5, the hose is first placed into the dispensing outlet notch 7, in order to prevent any kinks in hose during storage, the accidental removal of the hose from the dispensing outlet 4 during storage, or the movement of a pivoting dispensing outlet 4. In the arrangement shown in FIGS. 1-5, the dispensing hose notch 7 is a resilient c-shaped notch, and by virtue of using a deformable hose 5, the hose is held in place by pressure when the hose 5 is placed in the dispensing outlet notch 7. In other arrangements other means to hold the hose 5 in place may be utilized, such as clamps, hooks, or other attachment devices. After a portion of the hose 5 is secured in the dispensing outlet notch 7 the hose 5 can then be wrapped around the housing 1. A schematic of how the hose may be wrapped around the housing 1 is shown in FIG. 5. The hose 5 is wrapped around the housing 1 in the following manner: first, as the hose 5 is wrapped over the upper portion of the housing 1, the hose is placed in the grooves 9. Second, as the hose 5 wrapped under the housing, the hose 5 is placed in one of the storage notches 8. Therefore, using the grooves 9 as a guide, the hose 5 can be tightly wrapped around the housing 1 by virtue of the storage notches 8, minimizing the overall footprint of the stored funnel bucket device. In the arrangement shown in FIGS. 1-5, the storage notches 8 are resilient c-shaped notches, where the by virtue of using a deformable hose 5, the hose is held in place by pressure when the hose 5 is placed in the storage notches 7. In other arrangements, it may be possible to use hooks or other structures in place of the grooves 9 to guide the wrapping of the hose around the housing. Once the hose is sufficiently wrapped around the housing, the remaining hose portion may be placed into a one of the storage notches 7. However, in other arrangements, the hose 5 may be wrapped around the housing in alternate directions or ways.

In other arrangements, one side of the housing may be adapted for mounting. In the arrangement in FIGS. 1-5, only one side of the housing is designed to be a mounting side 10. In the various arrangements, the shape of the mounting side 10 generally does not affect the operation of the funnel bucket device; therefore, the mounting side 10 can be designed to accommodate various shapes of structures it will be mounted to. In the arrangement in FIGS. 1-5, the mounting side 10 has been designed to be attached to flat walls, round pilings, and square four-inch and eight-inch posts, by using screws, nails, or other fastening devices. In the arrangement shown in FIGS. 1-5, the mounting side 10 is further comprised of a series of keyhole screw mounting holes 11. As shown in FIG. 3, the mounting side 10 is comprised of a portion comprising a concave vertical channel 12, with a series of keyhole mounting holes 11, allowing the housing 1 to be mounted on a small post or a round post, rather than just on a flat wall or wide post.

In various arrangements, a means to transport the device may also be incorporated. In some arrangements, one or more handles 13 or finger holes 14 may be attached to or incorporated into the housing. In the arrangement shown in FIGS. 1-5, two handles 13 and two finger holes 14 have been incorporated into the housing, reducing the overall footprint of the apparatus. However, in other arrangements, the handles 13 or finger holes 14 may jut out of the housing. In yet other arrangements, the housing may have a means to transport, such as wheels or skids, or be attached to a cart or other transport device, which allows easy transport of the funnel bucket device.

In some arrangements, the housing may incorporate a lid 15 or cap to cover the opening on the upper portion of the housing. In the arrangement shown in FIGS. 1-5, the lid 15 is hingedly attached to the housing, allowing a user to flip open the lid 11 before inserting a liquid, and to flip the lid 11 closed after the liquid is inserted into the opening or when storing the liquid in the funnel bucket device. In some arrangements, the lid 11 may be weatherproof or waterproof in order to prevent contamination of the interior of the housing or of the liquid stored within.

In order to dispense liquid, the user must first transport the funnel bucket device to the desired location to dispense the liquid. In the arrangement shown in FIGS. 1-5, the funnel bucket device would be grasped by the handles 13 or finger holes 14 and transported to the desired location. In some instances, the housing could be placed on level ground and be supported by the support system 6. In other instances, the housing could be mounted on the mounting side 10 to a wall, post, or pylon, and secured by screws or nails in one or more of the mounting holes 11. Once the funnel bucket device is placed in the desired location, one end of a hose 5 is attached to the dispensing outlet 4 and the other end of the hose 5 is placed in the inlet of a destination liquid container or tank. Alternatively, the hose 5 may be uncoiled from around the housing 1 and the unattached end is attached or placed at the destination. The user would then open the lid 15 and pour or provide the liquid into the opening 2 of the housing 1. The liquid would then flow down the concave bottom 3 of the housing, flow out the dispensing outlet 4 and flow through the hose 5 to the inlet of the liquid container being filled. Once all the liquid is poured and liquid transfer is complete, the user may close the lid 15. The user can then remove the hose 5 from the dispensing outlet 4 and store or secure the hose 4 and housing 1. Alternative, the user can put the hose through the dispensing outlet notch 7, wrap the hose tightly around the housing, guided by the storage notches 8 and the grooves 9, and secure any remaining portion of the hose in one of the storage notches 8, as described previously. The user may then secure or store the funnel bucket device.

In another arrangement of the present invention, operative to store, transport, and dispense liquids, the funnel bucket device, as shown in FIGS. 1-5 may be transported to the source of the liquid required. The user would then fill the housing 1 with the desired liquid and transport it back to the location of the liquid container to be filled. In such arrangements, a flow control device, either attached to or as part of the dispensing outlet 4, may be necessary to prevent loss of the liquid during transport. Furthermore, a lid 15 may also be desirable in such arrangement. Once the destination for the liquid is reached, the operation to dispense the liquid can proceed as described above, except that it would not be necessary to open the lid 15, but it would be necessary to open any flow control device being used.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered illustrative only of the principles of the invention. Further, since numerous modifications and changes will readily occur to those skilled in the art, it is not desired to limit the invention to exact construction operation described and accordingly, and all suitable modifications and equivalents may be resorted to, falling within the scope of the invention.

What is claimed is:

1. A funnel bucket device for storing, transporting, and dispensing a liquid, comprising:
a housing defining a container for holding a liquid, the housing having a wide opening at an upper surface thereof for receiving liquids, having a generally concave inclined bottom surface, and having a support system on the bottom surface of the housing, wherein the support system supports the housing when the housing is placed on a substantially level surface;
a dispensing outlet connected to the housing and located at a low point of the inclined bottom surface, wherein a dispensing hose is connectable to the dispensing outlet;
a hose storage system formed by at least one hose storage notch, and at least one indented groove on an upper exterior part of the housing, the at least one indented groove located opposite to the at least one first hose notch located on a lower exterior part of the housing, and a dispensing outlet hose notch located adjacent to the dispensing outlet,
wherein a dispensing hose is removably stored by the hose storage system when not in use by wrapping the hose around the housing and securing the hose in place in the at least one indented groove and the at least one hose storage notch, and wherein the hose is secured in place adjacent to the dispensing device by the dispensing outlet hose notch, whereby the hose is not caused to be disengaged from the dispensing device or kinked by the action of wrapping the hose around the housing.

2. The funnel bucket device of claim 1, wherein the dispensing outlet is pivotably connected to the housing.

3. The funnel bucket device of claim 2, wherein the dispensing outlet can pivot through 90 degrees.

4. The funnel bucket device of claim 1, wherein the housing has at least one side adapted for mounting the housing.

5. The funnel bucket device of claim 1, further comprising a means to transport the funnel bucket device.

6. The funnel bucket device of claim 5, further comprising at least one handle attached to the housing.

7. The funnel bucket device of claim 1, further comprising a lid adapted to cover the wide opening at the upper surface of the housing.

8. The funnel bucket device of claim 7, wherein the lid is hingedly attached to the housing.

9. The funnel bucket device of claim 7, wherein the lid provides a weatherproof seal.

10. The funnel bucket device of claim 1, wherein the dispensing outlet is adapted to allow control of liquid flow.
